(19) United States
(12) Patent Application Publication
(10) Pub. No.: US 2026/0087462 A1
(43) Pub. Date: Mar. 26, 2026

(54) COMMUNICATION SYSTEM, INFORMATION PROCESSING APPARATUS, AND INFORMATION PROCESSING METHOD

(71) Applicant: TOYOTA JIDOSHA KABUSHIKI KAISHA, Toyota-shi (JP)

(72) Inventor: Iwao NITTA, Nagoya-shi (JP)

(73) Assignee: TOYOTA JIDOSHA KABUSHIKI KAISHA, Toyota-shi (JP)

(21) Appl. No.: 19/326,032

(22) Filed: Sep. 11, 2025

(30) Foreign Application Priority Data
Sep. 20, 2024 (JP) 2024-164388

(51) Int. Cl. G06Q 10/30

(52) U.S. Cl. CPC G06Q 10/30

(57) ABSTRACT

An information processing apparatus includes a controller configured to execute: determining an ownership ratio of a plurality of companies for a predetermined substance obtained by recycling battery packs of the plurality of companies; and outputting the ownership ratio thus determined. Determining the ownership ratio of the plurality of companies includes determining the ownership ratio according to the number of the battery packs recycled within the ownership of each of the plurality of companies, a weight per unit of the battery packs, and a content rate of a target metal contained per unit of the battery packs.

### CROSS REFERENCE TO THE RELATED APPLICATION

This application claims the benefit of Japanese Patent Application No. 2024-164388, filed on Sep. 20, 2024, which is hereby incorporated by reference herein in its entirety.

### BACKGROUND

### Technical Field

The present disclosure relates to a communication system, an information processing apparatus, and an information processing method.

### Description of the Related Art

Patent Literature 1 discloses a method for recovering valuable metals contained in waste batteries.

### CITATION LIST

### Patent Literature

Patent Literature 1: Japanese Patent Application Laid-Open Publication No. 2021-139020

### SUMMARY

An object of the present disclosure is to provide a technique effective in distinguishing a portion owned by each company for a substance obtained by simultaneously recycling battery packs of a plurality of companies.

One aspect of the present disclosure may be an information processing apparatus. In this case, the information processing apparatus may include a controller configured to execute, for example:
determining an ownership ratio of a plurality of companies for a predetermined substance obtained by recycling battery packs of the plurality of companies; and
outputting the ownership ratio thus determined;
wherein the controller is configured to determine the ownership ratio according to the number of the battery packs recycled within the ownership of each of the plurality of companies, a weight per unit of the battery packs, and a content rate of a target metal contained per unit of the battery packs.

Another aspect of the present disclosure may be an information processing method. The information processing method in this case may be, for example, an information processing method for causing a computer to execute:
determining an ownership ratio of a plurality of companies for a predetermined substance obtained by recycling battery packs of the plurality of companies; and
outputting the ownership ratio thus determined;
wherein the computer determines the ownership ratio according to the number of the battery packs recycled within the ownership of each of the plurality of companies, a weight per unit of the battery packs, and a content rate of a target metal contained per unit of the battery packs.

The present disclosure can also be considered as a program for causing a computer to execute the above-described information processing method or a computer readable storage medium that stores the program in a non-transitory manner.

A further aspect of the present disclosure may be a communication system. In this case, the communication system may include, for example:
a plurality of first terminals;
a second terminal; and
a server;
wherein each of the plurality of first terminals may be configured to transmit a first signal including a first data which includes a weight of battery packs to be recycled and a content rate of a target metal to the server; and
the second terminal may be configured to transmit a second signal including a second data which includes a number of battery packs to be recycled to the server;
wherein the server may be configured to execute:
   calculating, in response to receiving the first signals and the second signal, a first ratio regarding a material generated in the recycling process using the first data included in the first signal and the second data included in the second signal as parameters; and
   transmitting a third signal including the calculated first ratio to the plurality of first terminals.

According to the present disclosure, it is possible to provide a technique that is effective in distinguishing a portion owned by each company for a substance obtained by simultaneously recycling battery packs of a plurality of companies.

### BRIEF DESCRIPTION OF THE DRAWINGS

FIG. 1 is a view illustrating an overview of a system in an embodiment;

FIG. 2 is a diagram schematically illustrating an example of a hardware configuration of each of company terminals, a base terminal, and a management server included in the system in the embodiment;

FIG. 3 is a diagram schematically illustrating an example of recycling information in the embodiment;

FIG. 4 is a block diagram illustrating an example of a software configuration of the management server in the embodiment;

FIG. 5 is a diagram schematically illustrating an example of information stored in a battery management DB in the embodiment;

FIG. 6 is a diagram for explaining an example of a process of determining an ownership ratio in the embodiment;

FIG. 7 is a flowchart illustrating an example of a processing routine to be executed by the management server in the embodiment;

FIG. 8 is a diagram schematically illustrating an example of information stored in a battery management DB in a modified embodiment;

FIG. 9 is a diagram for explaining an example of a process of determining an ownership ratio in the modified embodiment; and

FIG. 10 is a flowchart illustrating an example of a processing routine executed by a management server in the modified embodiment.

### DESCRIPTION OF THE EMBODIMENTS

Regarding batteries (battery packs) for driving vehicles such as BEVs (Battery Electric Vehicles), HEVs (Hybrid Electric Vehicles), and PHEVs (Plug-in Hybrid Electric Vehicles), progress is being made in building a system for manufacturing new battery packs using a predetermined substance produced from used battery packs. In the system, it is ideal that a company, which manufactures and/or sells battery packs, manufactures new battery packs using a predetermined substance (e.g., black mass, active material, or the like) produced from used battery packs of the company. On the other hand, for a business operator who performs a process of recycling used battery packs, it is not realistic to recycle the used battery packs for each company in terms of cost, efficiency, and the like. Therefore, a method may be considered in which used battery packs from a plurality of companies are recycled all at once in a mixed state. If such a method is adopted, criteria will be needed for the allocation of the predetermined substance among the plurality of companies. In this case, if the allocation is determined based on the number of recycled used battery packs by company or the total weight thereof by company, companies that manufacture and/or sell battery packs containing relatively large amounts of metals with high market value or rarity value (e.g., lithium, cobalt, nickel, manganese, etc.) may be disadvantaged. Therefore, it is necessary to take measures to allocate the predetermined substance while reducing disadvantages of companies that manufacture battery packs containing relatively large amounts of metals with high market value or rarity value.

In order to solve the above-mentioned problems, an information processing apparatus, which is one aspect of the present disclosure, determines the allocation of a predetermined substance to a plurality of companies based on the number of battery packs recycled within the ownership of each of the plurality of companies, a weight per unit of the battery packs, and a content rate of a target metal contained per unit of the battery packs.

Specifically, in the information processing apparatus according to the present disclosure, the controller determines an ownership ratio of the plurality of companies for the predetermined substance obtained by recycling the battery packs of the plurality of companies. In this case, the controller in the present disclosure may determine the ownership ratio of the plurality of companies for the predetermined substance based on the number of battery packs recycled within the ownership of each of the plurality of companies, the weight per unit of the battery packs, and the content rate of the target metal contained per unit of the battery packs. The term “within the ownership of each company” may be the extent to which the company's ownership extends, or it may be the extent to which each company is responsible for the use of the predetermined substance in the manufacture of new battery packs. The target metal in the present disclosure is a metal that has a relatively high market value and/or rarity value among metals contained in the predetermined substance. In one example, the target metal may be a rare metal (e.g., lithium, cobalt, nickel, manganese, or the like) used for electrodes or the like of battery cells constituting the battery packs.

Here, the recycling process in the present disclosure may include a process of refining the black mass produced from the battery packs to separate and refine the target metal. The predetermined substance in this case may be the target metal produced by the recycling process. The ownership ratio of the plurality of companies may be an allocation ratio of the total weight of the target metal produced in the recycling process to the plurality of companies.

In the present embodiment, in the case where the predetermined substance is a target metal produced by the recycling process, determining the ownership ratio of the plurality of companies for the predetermined substance may include: calculating an ownership index value for each of the plurality of companies by multiplying the number of battery packs recycled within the ownership of each of the plurality of companies, the weight per unit of the battery packs, and the content rate of the target metal contained per unit of the battery packs; and setting a ratio of the index values among the plurality of companies as the allocation ratio to the plurality of companies. Note that the method of determining the ownership ratio in such a manner is not limited to the case where the predetermined substance is a target metal, but can also be applied to the case where the predetermined substance is an active material containing one kind of target metal (which may contain substances other than the target metal).

In addition, the recycling process in the present disclosure may include a process of producing a black mass from a battery pack (a process of pulverizing battery cells included in a battery pack after detoxifying the battery cell and then sorting the black mass). The predetermined material in this case may be the black mass produced by the recycling process. The ownership ratio of the plurality of companies may be the allocation ratio of the total weight of the black mass produced in the recycling process to the plurality of companies.

In a case where the predetermined substance according to the present disclosure is the black mass produced by the recycling process, the predetermined substance may contain two or more kinds of target metals. Thus, in the case where the predetermined substance is the black mass produced by the recycling process, determining the ownership ratio of the plurality of companies for the predetermined substance may include: calculating a weighted sum of the content rates of two or more kinds of target metals contained per unit of the battery packs recycled within the ownership of each of the plurality of companies; calculating an ownership index value for each of the plurality of companies by multiplying the number of battery packs recycled within the ownership of each of the plurality of companies, the weight per unit of the battery packs, and the weighted sum of the two or more target metals contained per unit of the battery packs; and setting a ratio of the index values among the plurality of companies as the ownership ratio. Weighting values used when calculating the weighted sum of two or more target metals (weighting coefficients multiplied respectively by the content rates of the two or more target metals) may, in one example, be set to larger as the respective market values or rarity values of the two or more target metals are higher. Note that the method of determining the ownership ratio in this manner is not limited to the case where the predetermined substance is black mass, but can also be applied to the case where the predetermined substance is an active material containing two or more kinds of target metals.

When the ownership ratio of the plurality of companies for the predetermined substance is determined as described above, the controller of the information processing apparatus according to the present disclosure outputs the determined ownership ratio of the plurality of companies. Outputting the ownership ratio of the plurality of companies may include, in one example, transmitting a signal for outputting the ownership ratio of the plurality of companies to a terminal of each of the plurality of companies.

According to the information processing apparatus of the present disclosure, the allocation of the predetermined substance to the plurality of companies can be determined based on the number of battery packs recycled within the ownership of each of the plurality of companies and the weight per unit of the battery packs, as well as the content rate(s) of the target metal(s) contained per unit of the battery packs. This makes it possible to allocate the predetermined substance while reducing disadvantages to companies that manufacture battery packs containing relatively large amounts of metals with high market value or rarity value. Therefore, it is possible to provide an effective technique for distinguishing the ownership (share) of each company for the predetermined substance that is produced by simultaneously recycling the battery packs of the plurality of companies.

Hereinafter, specific embodiments of the present disclosure will be described based on the accompanying drawings. The hardware configuration, module configuration, functional configuration, and the like described in the following embodiments are not intended to limit the technical scope of the disclosure only to them unless otherwise specified.

### EMBODIMENT

In the present embodiment, an example will be described in which an information processing apparatus according to the present disclosure is applied to a system that simultaneously recycles a plurality of battery packs which are a mixture of battery packs from a plurality of companies. The battery packs in the present embodiments are used driving batteries collected from vehicles such as BEVs, PHEVs, HEVs, etc.

### (Overview of System)

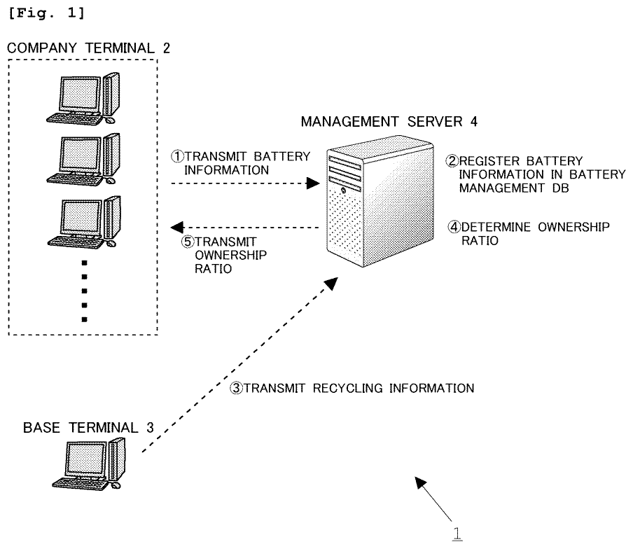

FIG. 1 is a view illustrating a schematic configuration of a system 1 according to the present embodiment. In the example of FIG. 1, the system 1 is configured to include company terminals 2 located at each of a plurality of companies, a base terminal 3 located at a base where a recycling process is carried out (hereinafter sometimes referred to as a “recycling base”), and a management server 4. The management server 4 is connected to the company terminals 2 and the base terminal 3 via a network. The network is, for example, a worldwide public communication network such as the Internet or the like, and a WAN (Wide Area Network) or other communication networks may be adopted. Also, the may network include a telephone communication network such as a mobile phone network or the like, and/or a wireless communication network such as Wi-Fi (registered trademark) or the like. Note that in the example illustrated in FIG. 1, only one recycling base is illustrated, but a plurality of recycling bases may be included in the system 1. Accordingly, a plurality of base terminals 3 may be included in the system 1.

The company terminals 2 are each a computer located at a company that manufactures battery packs and/or a company that sells battery packs manufactured by other companies (OEM-produced battery packs). In the present embodiment, the company terminals 2 each have a function of providing the management server 4 with information on products of battery packs to be manufactured and/or sold (hereinafter also referred to as “battery information”). The battery information in the present embodiment includes the product ID of each battery pack, the weight per unit of the battery packs, the content rate of a target metal contained per unit of the battery packs, and the like. The product ID is an identifier (e.g., a product name, a model number or the like) for identifying each battery pack product. The battery information may be provided to the management server 4 at the time when each battery pack product is placed on the market (e.g., when a vehicle equipped with each product is first sold), or at a predetermined time after each product is placed on the market (e.g., at the time when each product is presumed to be collected for recycling). In addition, the company terminals 2 in the present embodiment each also have a function of presenting the ownership ratio provided from the management server 4 to an operator of each company terminal 2 (an employee or the like of each company).

The base terminal 3 is a computer located at a base (recycling base) that performs, as a business, the recycling process of battery packs collected from vehicles. In the present embodiment, it is assumed that a plurality of battery packs are simultaneously recycled at a recycling base in a state where products of a plurality of companies are mixed. The base terminal 3 in the present embodiment has a function of providing the management server 4 with information about the battery packs that have been subject to the recycling process within a predetermined period (hereinafter, sometimes referred to as “recycling information”) each time the predetermined period has elapsed. The predetermined period is a period appropriately set according to the timing of collection of the battery packs and/or the amount of collected battery packs, and in one example, may be set within a range from several days to one month. The recycling information in the present embodiment includes the total weight of the predetermined substance produced by the recycling process within the predetermined period and the number of battery packs for each product ID that have been subjected to the recycling process within the predetermined period. Note that the recycling information may be transmitted from the base terminal 3 to the management server 4 each time the recycling process is performed at the recycling base. The recycling information in this case may include the amount of the predetermined substance produced in one recycling process and the number of battery packs subjected to one recycling process for each product ID.

The recycling process carried out at the recycling base in the present embodiment includes a step of detoxifying the battery cells removed from the battery packs, crushing them, and sorting out black mass, and a step of refining the black mass to separate and refine rare metals (target metals) that have high market value and/or rarity value, such as lithium (Li), nickel (Ni), cobalt (Co), manganese (Mn), etc.

Therefore, the predetermined substance produced by the recycling process in the present embodiment may be a target metal. In this case, the target metal contained in the predetermined substance is only one kind. Note that the predetermined substance may be an active material containing only one of the target metals described above. In this case, the recycling process may include, in addition to the steps described above, a step of producing a cathode active material using one of a plurality of kinds of rare metals produced from the black mass. Note that the plurality of steps described above may be performed at one recycling base, or may be shared and performed at a plurality of recycling bases.

The management server 4 is one or more computers that execute information processing related to the predetermined substance produced by simultaneously recycling battery packs of the plurality of companies. Each time receiving battery information transmitted from each of the plurality of company terminals 2, the management server 4 of the present embodiment has a function of registering the received battery information in a battery management DB 421 to be described later. In addition, each time receiving the recycling information transmitted from the base terminal 3, the management server 4 of the present embodiment has a function of determining the ownership ratio among the plurality of companies for the predetermined substance produced in the recycling process (the allocation ratio of the predetermined substance among the plurality of companies), and transmitting the ownership ratio thus determined to the company terminal 2 of each of the plurality of companies.

### (Hardware Configuration of System)

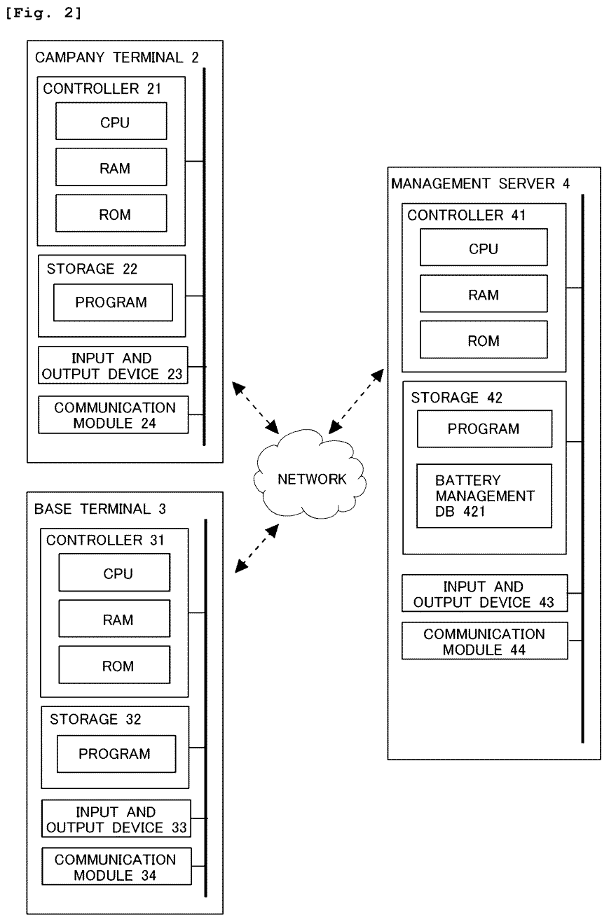

A hardware configuration example of each of a company terminal 2, the base terminal 3, and the management server 4 included in the system 1 in the present embodiment will be described based on FIG. 2. FIG. 2 is a diagram schematically illustrating an example of the hardware configuration of each of the company terminal 2, the base terminal 3, and the management server 4 included in the system 1 in the present embodiment.

The company terminal 2 is a computer located in each of the plurality of companies, and includes a controller 21, a storage 22, an input and output device 23, and a communication module 24.

The company terminal 2 can be configured as a computer having a processor (CPU, GPU, or the like), a main memory (RAM, ROM, or the like), and an auxiliary memory (EPROM, hard disk drive, removable medium, or the like). In the auxiliary memory, a program, data used by the program, and the like are stored, and each function (software module) that matches a predetermined purpose can be realized by processor executing the program stored therein. However, some or all of the functions of the company terminal 2 may be implemented as a hardware module by a hardware circuit such as an ASIC (Application Specific Integrated Circuit), a FPGA (Field Programmable Gate Array) or the like.

The controller 21 is an arithmetic logic unit that realizes various functions (software modules) of the company terminal 2 by executing the program stored in the auxiliary memory. The controller 21 can be realized by, for example, a hardware processor such as a CPU or the like. In addition, the controller 21 may be configured to include a RAM (Random Access Memory), a ROM (Read Only Memory), a cache memory, etc.

The storage 22 stores information, and is constituted by a storage medium such as a RAM, a magnetic disk, a flash memory or the like. In the storage 22, a program executed by the controller 21, data used by the program, and the like are stored.

The input and output device 23 is a device for receiving an input operation performed by an operator of the company terminal 2 (an employee of a company) and presenting information to the operator. Specifically, the input and output device 23 includes a device for performing an input, such as a mouse, a keyboard, etc., and a device for performing an output, such as a display, a speaker, etc. The input and output device 23 may be integrally configured by, for example, a touch panel display or the like.

The communication module 24 is a communication interface for connecting the company terminal 2 to the network. The communication module 24 may be configured to include, for example, a network interface board, a wireless communication interface for wireless communication, and the like. The company terminal 2 can perform data communication with another computer (e.g., the management server 4 or the like) via the communication module 24.

Note that the specific hardware configuration of the company terminal 2 can omit, replace, and add its components as appropriate according to its implementation.

In the company terminal 2 configured as described above, an operator of a company inputs battery information through the input and output device 23. In response to the input of the battery information, the controller 21 transmits the input battery information to the management server 4 through the communication module 24. A timing at which the operator inputs the battery information may be a timing at which a product (battery pack) of the company appears on the market, or may be a predetermined timing after a timing at which the product of the company appears on the market.

In addition, in the company terminal 2 configured as described above, in response to the fact that the communication module 24 receives the ownership ratio transmitted from the management server 4, the controller 21 outputs the received ownership ratio through the input and output device 23 (presents to the operator).

Next, a hardware configuration example of the base terminal 3 will be described. The base terminal 3 in the present embodiment is a computer located at a recycling base, and includes a controller 31, a storage 32, an input and output device 33, and a communication module 34.

Similar to the company terminal 2, the base terminal 3 can be configured as a computer having a processor (CPU, GPU, or the like), a main memory (RAM, ROM, or the like), and an auxiliary memory (EPROM, hard disk drive, removable medium, or the like). In the auxiliary memory, a program, data used by the program, and the like are stored, and each function (software module) that matches a predetermined purpose can be realized by the processor executing the program stored therein. However, some or all of the functions of the base terminal 3 may be implemented as a hardware module by a hardware circuit.

The controller 31 is an arithmetic logic unit that realizes various functions (software modules) of the base terminal 3 by executing the program stored in the auxiliary memory. The controller 31 can be realized by, for example, a hardware processor such as a CPU or the like. In addition, the controller 21 may be configured to include a RAM, a ROM, a cache memory, etc.

The storage 32 is a means for storing information, and is constituted by a storage medium such as a RAM, a magnetic disk, a flash memory or the like. In the storage 32, a program executed by the controller 31, data used by the program, and the like are stored.

The input and output device 33 is a means for receiving an input operation performed by an operator of the base terminal 3 (an employee of the recycling base) and presenting information to the operator. Specifically, the input and output device 33 includes a device for performing an input, such as a mouse, a keyboard, etc., and a device for performing an output, such as a display, a speaker, etc. The input and output device 33 may be integrally configured by, for example, a touch panel display or the like.

The communication module 34 is a communication interface for connecting the base terminal 3 to the network. The communication module 34 may be configured to include, for example, a network interface board, a wireless communication interface for wireless communication, and the like. The base terminal 3 can perform data communication with another computer (e.g., the management server 4 or the like) via the communication module 34.

Note that the specific hardware configuration of the base terminal 3 can omit, replace, and add its components as appropriate according to its implementation.

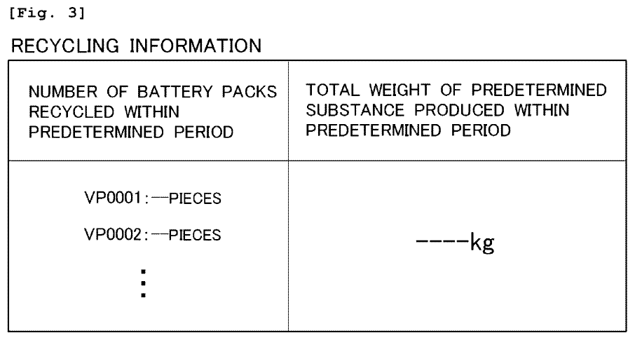

In the base terminal 3 configured as described above, each time the predetermined period elapses, the controller 31 transmits the recycling information about the battery packs (products) that have been subject to the recycling process within the predetermined period to the management server 4 via the communication module 34. In this case, each time the recycling process is performed within the predetermined period, the operator of the recycling base may input information on the battery pack (product) subjected to the recycling process through the input and output device 33. The controller 31 of the base terminal 3 may store the input information in the storage 42. Then, at the timing when the predetermined period has elapsed, the controller 31 of base terminal 3 may generate the recycling information by extracting from the storage 32 the number of battery packs for each product that have been recycled within the predetermined period and the total weight of the predetermined substance produced by the recycling process performed within the predetermined period. As illustrated in FIG. 3, the recycling information may include the number of battery packs recycled within the predetermined period for each product ID and the total weight (kg) of the predetermined substance produced by the recycling process performed within the predetermined period.

Note that the timing of transmitting the recycling information to the management server 4 is not limited to the above-described example, and the recycling information may be transmitted from the base terminal 3 to the management server 4 each time a recycling process is performed. The recycling information in this case may include the amount of the predetermined substance produced in one recycling process and the number of battery packs (products) subjected to one recycling process for each product ID.

Next, a hardware configuration example of the management server 4 will be described. The management server 4 in the present embodiment is configured as a computer including a controller 41, a storage 42, a communication module 44, and an input and output device 43.

The management server 4 is an example of the information processing apparatus according to the present disclosure. Similar to the company terminal 2, the management server 4 can be configured as a computer having a processor (CPU, GPU, or the like), a main memory (RAM, ROM, or the like), and an auxiliary memory (EPROM, hard disk drive, removable medium, or the like). However, in the auxiliary memory of the management server 4, a program, data used by the program, and the like are stored, and each function (software module) that matches a predetermined purpose, as will be described later, can be realized by the processor executing the program stored therein. However, some or all of the modules of the management server 4 may be implemented as hardware modules by hardware circuits.

The controller 41 is an arithmetic logic unit that realizes various functions of the management server 4 by executing the program stored in the auxiliary memory. The controller 41 can be realized by, for example, a hardware processor such as a CPU or the like. In addition, the controller 41 may be configured to include a RAM, a ROM, a cache memory, etc.

The storage 42 is a means for storing information, and is constituted by a storage medium such as a RAM, a magnetic disk, a flash memory or the like. In the storage 42, a program executed by the controller 41, data used by the program, and the like are stored. In addition, in the storage 42, a battery management DB 421 is built, and battery information and the like provided from the plurality of company terminals 2 are stored in the battery management DB 421. Details of the battery management DB 421 stored in the storage 42 will be described later.

The input and output device 43 is a means that receives an input operation performed by an operator of the management server 4 and presents information to the operator. Specifically, the input and output device 43 includes a device for performing an input, such as a mouse, a keyboard, etc., and a device for performing an output, such as a display, a speaker, etc. The input and output device 43 may be integrally configured by, for example, a touch panel display or the like.

The communication module 44 is a communication interface for connecting the management server 4 to the network. The communication module 44 may be configured to include, for example, a network interface board, a wireless communication interface for wireless communication, and the like. The management server 4 can perform data communication with other computers (e.g., the company terminals 2, the base terminal 3, etc.) via the communication module 44.

Note that the specific hardware configuration of the management server 4 can omit, replace, and add its components as appropriate according to its implementation. For example, the controller 41 may: plurality of hardware processors. The hardware processor may be constituted by a microprocessor, an FPGA, a GPU, etc. In addition, the input and output device 43 may be omitted, or an input and output device other than those exemplified (e.g., an optical drive or the like) may be added. Also, the management server 4 may be constituted by a plurality of computers. In this case, the hardware configurations of the respective computers may or may not match each other.

### (Software Configuration of Management Server)

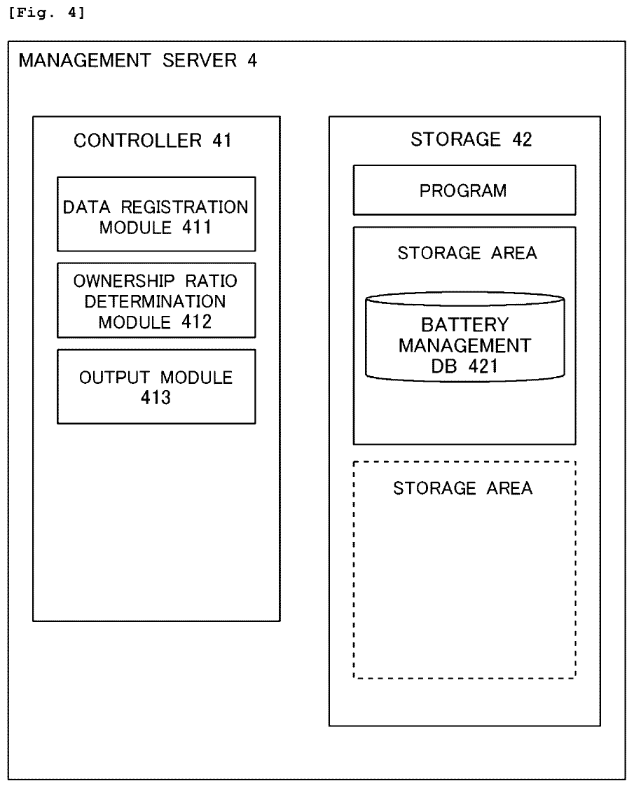

Here, functions realized by the management server 4 in the present embodiment will be described. FIG. 4 is a diagram schematically illustrating an example a of software configuration of the management server 4 in the present embodiment. In the present embodiment, the controller 41 of the management server 4 is configured to have a plurality of software modules including a data registration module 411, an ownership ratio determination module 412, and an output unit 413. Each software module is implemented by the controller 41 executing the program in the storage 42. Note that at least a part of the data registration module 411, the ownership ratio determination module 412, and the output unit 413 may be implemented by a hardware circuit such as an ASIC, an FPGA or the like. In addition, in the following description, the information processing by executed of data each the registration module 411, the ownership ratio determination module 412, and the output unit 413 is synonymous with the information processing executed by the controller 41.

The data registration module 411 is configured to execute a process of receiving the battery information transmitted from the company terminal 2 of each of the plurality of companies through the communication module 44. Furthermore, the data registration module 411 is configured to execute a process of storing the received battery information in the battery management DB 421 of the storage 42.

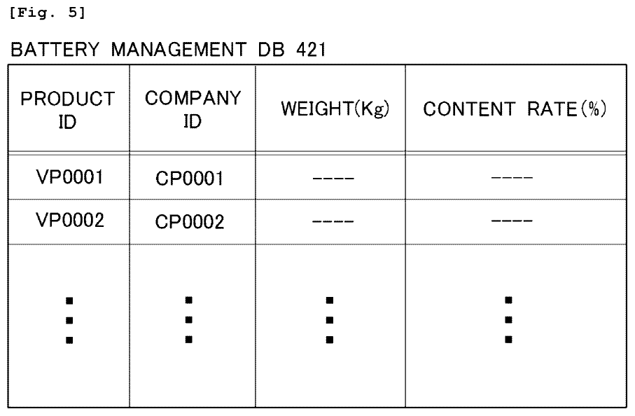

Here, the battery management DB 421 built in the storage 42 of the management server 4 will be described. FIG. 5 is a view illustrating an example of the information stored in the battery management DB 421. The battery management DB 421 in the present embodiment stores information on battery packs for each product. In the example illustrated in FIG. 4, the battery management DB 421 has a plurality of records for each battery pack product. Each record includes a plurality of fields such as a product ID field, a company ID field, a weight field, and a content rate field. In the product ID field, an identifier (product ID) for identifying each battery pack product is registered. The information registered in the product ID field may be a product name, a model number or the like of each battery pack product. In the company ID field, an identifier (company ID) for identifying a company that manufactures and/or sells each battery pack product is registered. In the weight field, the weight (kg) per unit of each battery pack product is registered. In the content rate field, the content rate (%) of the target metal contained per unit of each battery pack product is registered. The records in the battery management DB 421 are generated and added by the controller 41 each time the communication module 44 receives information transmitted from the company terminal 2.

Note that the battery management DB 421 may be built in an external device connected to the management server 4 via the network.

Returning to FIG. 4, the ownership ratio determination module 412 will be described. The ownership ratio determination module 412 in the present embodiment is configured to execute a process of receiving the recycling information transmitted from the base terminal 3 through the communication module 44. Further, the ownership ratio determination module 412 is configured to execute a process of determining the ownership ratio of the plurality of companies for the predetermined substance produced by the recycling process performed within the predetermined period according to the received recycling information.

In the process of determining the ownership ratio of the plurality of companies, the ownership ratio determination module 412 first accesses the battery management DB 421 in the storage 42 using, as an argument, each of a plurality of product IDs included in the recycling information as illustrated in

FIG. 3, and identifies a plurality of records in which information matching each of the plurality of product IDs is registered in the product ID field. The ownership ratio determination module 412 identifies a plurality of companies that are targets of the ownership ratio (hereinafter, also sometimes referred to as “target companies”) according to information (company ID) registered in the company ID field in each of the plurality of records identified. In addition, the ownership ratio determination module 412 extracts information (the weight per unit of the battery packs and the content rate per unit of the target metal) registered in the weight field and the content rate field in each of the plurality of records identified. The ownership ratio determination module 412 calculates an ownership index value for each of the plurality of target companies by substituting, into the following formula (1), the number included in the recycling information (the number of products (battery packs) of the target companies that have been recycled during the predetermined period), and the weight and the content rate extracted from the battery management DB 421 (the weight per unit of the products (battery packs) and the content rate of the target metal per unit of the products of the target companies that have been recycled during the predetermined period).

$$( Index value ) = ( number ) \times ( weight ) \times ( content rate ) \qquad ( 1 )$$

When finishing the calculation of the index values for all of the plurality of target companies, the ownership ratio determination module 412 sets the ratio of these index values as the ownership ratio among the plurality of target companies.

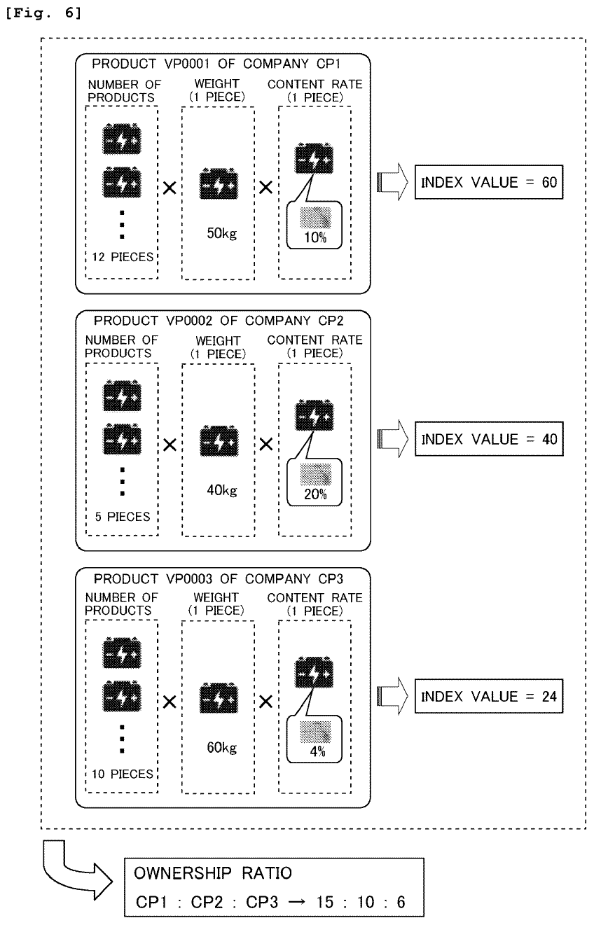

FIG. 6 is a diagram for explaining an example of the process of determining the ownership ratio. In the example illustrated in FIG. 6, the battery packs recycled at a recycling base within the predetermined period include product VP0001 of company CP1, product VP0002 of company CP2, and product VP0003 of company CP3. The number of products recycled at the recycling base within the predetermined period is 12 for product VP0001, 5 for product VP0002, and 10 for product VP0003. The weight per unit of each of product VP0001, product VP0002, and product VP0003 is 50 kg, 40 kg, and 60 kg, respectively. The content rate of the target metals per unit of each of product VP0001, product VP0002, and product VP0003 is 10%, 20%, and 4%, respectively.

In the example illustrated in FIG. 6, when the index values corresponding to product VP0001, product VP0002, and product VP0003 are calculated according to the above formula (1), the following results are obtained.

$$Index value of product VP 0001 = 12 ( pieces ) \times 50 ( kg ) \times 0.1 ( 10 \% ) = 60 \\ Index value of product VP 0002 = 5 ( pieces ) \times 40 ( kg ) \times 0.2 ( 20 \% ) = 40 \\ Index value of product VP 0003 = 10 ( pieces ) \times 60 ( kg ) \times 0.04 ( 4 \% ) = 24$$

Therefore, the ownership ratio of company CP1, company CP2, and company CP3 is as follows.
CP1:CP2:CP3=15:10:6

In addition, when the amounts of allocation of the predetermined substance are determined according to the ownership ratio, the amounts of the predetermined substance allocated to company CP1, company CP2, and company CP3, respectively, are as follows.

$$Allocation amount of company CP 1 = ( total weight of predetermined substance ) \times ( 15 / 31 ) \\ Allocation amount of company CP 2 = ( total weight of predetermined substance ) \times ( 10 / 31 ) \\ Allocation amount of company CP 3 = ( total weight of predetermined substance ) \times ( 6 / 31 )$$

Returning back to FIG. 4, the output unit 413 will be described. The output unit 413 in the present embodiment is configured to execute a process of outputting the ownership ratio determined by the ownership ratio determination module 412. The process of outputting the ownership ratio includes at least a process of outputting the ownership ratio to the input and output devices 23 of the company terminals 2 of the target companies, among a process of outputting the ownership ratio to the input and output device 43 of the management server 4 and the process of outputting the ownership ratio to the input and output devices 23 of the company terminals 2 of the target companies. In the process of outputting the ownership ratio to the input and output devices 23 of the company terminals 2 of the target companies, the output unit 413 may simply transmit a signal for outputting the ownership ratio determined by the ownership ratio determination module 412 to the company terminals 2 of the target companies via the communication module 44.

### (Flow of Processing)

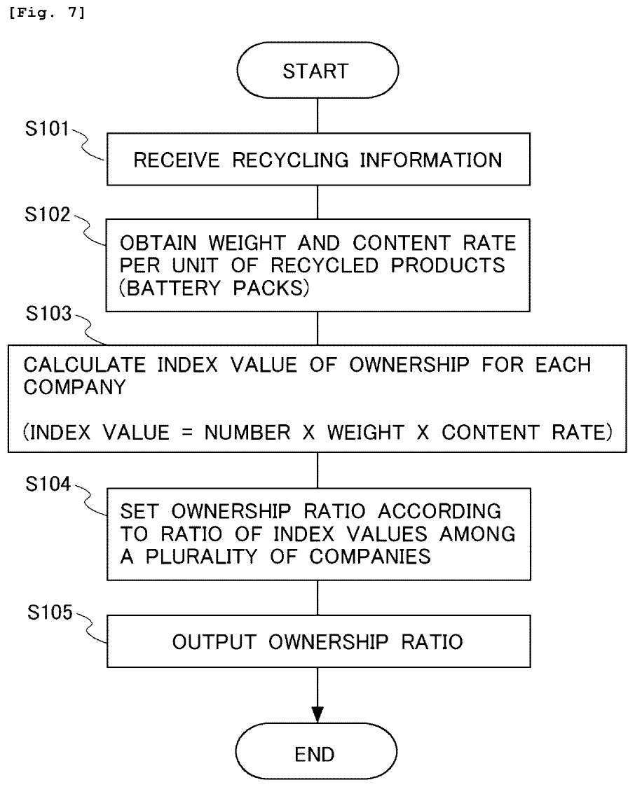

Next, a flow of processing executed by the management server 4 in the present embodiment will be described based on FIG. 7. FIG. 7 is a flowchart illustrating an example of a processing routine executed by the management server 4 with the reception of the recycling information transmitted from the base terminal 3 as a trigger. The main executor of the processing routine of FIG. 7 is the processor (controller 41) of the management server 4, but here, the software module of the management server 4 will be described as the main executor.

In the processing routine of FIG. 7, when the communication module 44 receives the recycling information transmitted from the base terminal 3, the controller 41 operates as the ownership ratio determination module 412 to obtain the recycling information received by the communication module 44 (step S101). After finishing the process of step S101, the ownership ratio determination module 412 executes the process of step S102.

In step S102, the ownership ratio determination module 412 accesses the battery management DB 421 in the storage 42 using, as an argument, each of the plurality of product IDs included in the recycling information received in step S102, and identifies a plurality of records in which information matching each of the plurality of product IDs is registered in the product ID field. The ownership ratio determination module 412 identifies the plurality of target companies according to the company ID registered in the company ID field in each of the plurality of records identified. In addition, the ownership ratio determination module 412 extracts information registered in the weight field and the content rate field in each of the plurality of records identified, thereby obtaining the weight per unit of the products (battery packs) and the content rate of the target metal per unit of the products, of each of the plurality of target companies. After finishing the process of step S102, the ownership ratio determination module 412 executes the process of step S103.

In step S103, the ownership ratio determination module 412 calculates the ownership index value for each of the plurality of target companies by substituting, into the above-mentioned formula (1), the number of products (battery packs) included in the recycling information, the weight per unit of the products (battery packs) extracted from the battery management DB 421, and the content rate of the target metal for each of the products (battery packs) extracted from the battery management DB 421 (see, for example, FIG. 6). After finishing the process of step S103, the ownership ratio determination module 412 executes the process of step S104.

In step S104, the ownership ratio determination module 412 determines the ownership ratio among the plurality of target companies for the predetermined substance produced by the recycling process performed during the predetermined period, according index to the values corresponding respectively to the plurality of target companies calculated in step S103. Specifically, the ownership ratio determination module 412 sets a relative ratio of the plurality of index values corresponding to the plurality of target companies as the ownership ratio among the plurality of target companies. After the ownership ratio determination module 412 finishes executing the process of step S104, the controller 41 operates as the output unit 413 to execute the process of step S105.

In step S105, the output unit 413 executes a process of outputting the ownership ratio determined in step S104. In the process of outputting the ownership ratio, the output unit 413 includes at least the process of outputting the ownership ratio to the input and output devices 23 of the company terminals 2 of the target companies, among the process of outputting the ownership ratio to the input and output device 43 of the management server 4 and the process of outputting the ownership ratio to the input and output devices 23 of the company terminals 2 of the target companies. In the process of outputting the ownership ratio to the input and output devices 23 of the company terminals 2 of the target companies, the output unit 413 transmits, to the company terminals 2 of the target companies via the communication module 44, a signal configured to output the ownership ratio determined in step S104 to the input and output devices 23 of the company terminals 2 of the target companies. When the output unit 413 finishes executing the process of step S105, the controller 41 ends the execution of the processing routine of FIG. 7.

### Operation and Effects of Embodiment

In the embodiment described above, in a case where products (battery packs) of a plurality of companies are simultaneously recycled, the management server 4 determines the ownership ratio of the plurality of companies for the predetermined substance by multiplying the total weight of the products (battery packs) of each of the plurality of target companies (the weight obtained by multiplying the number of recycled products by the weight per unit of the products) by the content rate of the target metal per unit of the products. This allows the ownership ratio of each target company to be increased as the content rate of the target metal thereof increases. Accordingly, the amount of allocation of the predetermined substance to each target company can be increased as the content rate of the target metal increases. Therefore, it is possible to allocate or distribute the predetermined substance to the plurality of target companies while reducing disadvantages of a target company that has manufactured and/or sold a product (battery pack) containing more of the target metal with high market value or scarcity value than the products of other target companies.

### Modified Embodiment

In the above-described embodiment, the case has been described where there is only one kind of target metal included in a predetermined substance. On the other hand, in the present modified embodiment, the case will be described where two or more kinds of target metals are included in a predetermined substance.

The recycling process performed at a recycling base in the present modified embodiment includes a step of detoxifying battery cells removed from battery packs, then crushing the battery cells, and separating or sorting out black mass. Therefore, a predetermined substance produced by the recycling process in the present modified embodiment is a black mass containing a plurality of kinds of rare metals (target metals) such as lithium (Li), nickel (Ni), cobalt (Co), manganese (Mn), etc. Note that the predetermined substance in the present modified embodiment may be a cathode active material produced using two or more kinds of rare metals among the plurality of kinds of rare metals produced from the black mass. The recycling treatment in this case may include, in addition to the above-described steps, a step of sorting the black mass, a step of refining the black mass to separate and purify a plurality of kinds of rare metals such as lithium (Li), nickel (Ni), cobalt (Co), manganese (Mn), etc., and a step of producing a cathode active material using two or more kinds of rare metals among the plurality of kinds of rare metals.

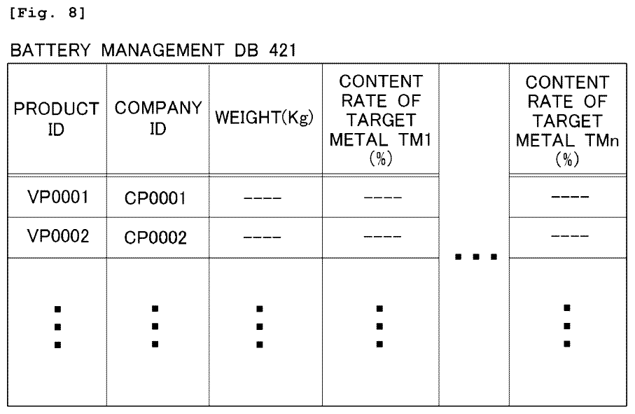

In addition, as illustrated in FIG. 8, the battery management DB 421 built in the storage 42 of the management server 4 in the present modified embodiment stores, for each product, a record having content rate fields corresponding respectively to two or more kinds of target metals (n fields corresponding respectively to n kinds of target metals from target metal TM1 to target metal TMn (n is an integer of 1 or more)), in addition to a product ID field, a company ID field, and a weight field. The n kinds of target metals from target metal TM1 to target metal TMn are metals contained in the predetermined substance (black mass) produced in the recycling process at the recycling site.

In addition, in the present modified embodiment, when determining the ownership ratio of a plurality of target companies for the predetermined substance, the ownership ratio determination module 412 of the management server 4 calculates a weighted sum of the content rates of n kinds of target metals contained per unit of the products of the target companies. Weighting coefficients used to calculate the weighted sum (by which the content rates are respectively multiplied) may be determined according to the respective market values or rarity values of the n kinds of target metals. In this case, the weighting values (coefficients) may be determined to be larger as the market values or rarity values of the target metals are higher. Once the weighted sum of each of the products of the plurality of target companies has been calculated, the ownership ratio determination module 412 calculates an ownership index value for each of the plurality of target companies by substituting, into the following formula (2), the number included in the recycling information (the number of products (battery packs) of each target company that have been recycled during the predetermined period), the weight extracted from the battery management DB 421 (the weight per unit of the products (battery packs) of each target company that have been recycled during the predetermined period), and the weighted sum (the weighted sum of the content rates of the n kinds of target metals contained per unit of the products (battery packs) of each target company that have been recycled during the predetermined period).

$$( Index value ) = ( number ) \times ( weight ) \times ( Σ ( content rate \times weighting value ) ) \qquad ( 2 )$$

In formula (2), ¿ (content rate× weighting value) is the weighted sum of the content rates of the n kinds of target metals.

When finishing the calculation of the index values for all of the plurality of target companies, the ownership ratio determination module 412 sets the ratio of these index values as the ownership ratio among the plurality of target companies.

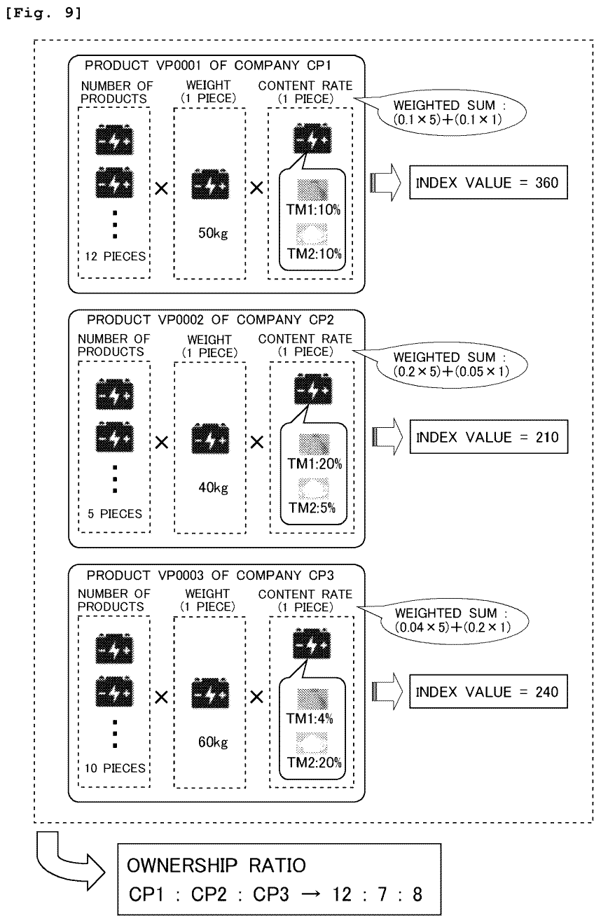

FIG. 9 is a diagram for explaining an example of a process of determining ownership ratio in the present modified embodiment. In the example illustrated in FIG. 9, the battery packs recycled at a recycling base within the predetermined period include product VP0001 of company CP1, product VP0002 of company CP2, and product VP0003 of company CP3. The numbers of products recycled at the recycling base within the predetermined period are 12 for product VP0001, 5 for product VP0002, and 10 for product VP0003, respectively. The weight per unit of each of product VP0001, product VP0002, and product VP0003 is 50 kg, 40 kg, and 60 kg, respectively. The target metals contained per unit of each of product VP0001, product VP0002, and product VP0003 are the kinds of target metal TM1 and target metal TM2. The content rates of target metal TM1 and target metal TM2 contained per unit of product VP0001 are 10% and 10%, respectively. The content rates of target metal TM1 and target metal TM2 contained per unit of product VP0002 are 20% and 5%, respectively. The content rates of target metal TM1 and target metal TM2 contained per unit of product VP0003 are 4% and 20%, respectively. In addition, the weighting values corresponding respectively to target metal TM1 and target metal TM2 are “5” and “1”, respectively.

In the example illustrated in FIG. 9, the weighted sum of each of product VP0001, product VP0002, and product VP0003 is as follows.

$$Weighted sum of product VP 0001 = ( 0.1 ( content rate of TM 1 ) \times 5 ( weighting value of TM 1 ) ) + ( 0.1 ( content rate of TM 2 ) \times 1 ( weighted value of TM 2 ) ) = 0.6 \\ Weighted sum of product VP 0002 = ( 0.2 ( content rate of TM 1 ) \times 5 ( weighting value of TM 1 ) ) + ( 0.05 ( content rate of TM 2 ) \times 1 ( weighted value of TM 2 ) ) = 1.05 \\ Weighted sum of product VP 0003 = ( 0.04 ( content rate of TM 1 ) \times 5 ( weighting value of TM 1 ) ) + ( 0.2 ( content rate of TM 2 ) \times 1 ( weighted value of TM 2 ) ) = 0.4$$

In the example illustrated in FIG. 9, when the index values corresponding respectively to product VP0001, product VP0002, and product VP0003 are calculated according to the above formula (2), the following results are obtained.

$$Index value of product VP 0001 = 12 ( pieces ) \times 50 ( kg ) \times 0.6 ( weighted sum ) = 360 \\ Index value of product VP 0002 = 5 ( pieces ) \times 40 ( kg ) \times 1.05 ( weighted sum ) = 210 \\ Index value of product VP 0003 = 10 ( pieces ) \times 60 ( kg ) \times 0.4 ( weighted sum ) = 240$$

Therefore, the ownership ratio of company CP1, company CP2, and company CP3 is as follows.
CP1:CP2:CP3=12:7:8

In addition, when the amounts of allocation of the predetermined substance are determined according to the ownership ratio, the amounts of the predetermined substance allocated to company CP1, company CP2, and company CP3, respectively, are as follows.

$$Allocation amount of company CP 1 = ( total weight of predetermined substance ) \times ( 12 / 27 ) \\ Allocation amount of company CP 2 = ( total weight of predetermined substance ) \times ( 7 / 27 ) \\ Allocation amount of company CP 3 = ( total weight of predetermined substance ) \times ( 8 / 27 )$$

Note that the configuration other than the battery management DB 421 and the ownership ratio determination module 412 is the same as that of the above-described embodiment, and thus the description thereof will be omitted.

### (Flow of Processing)

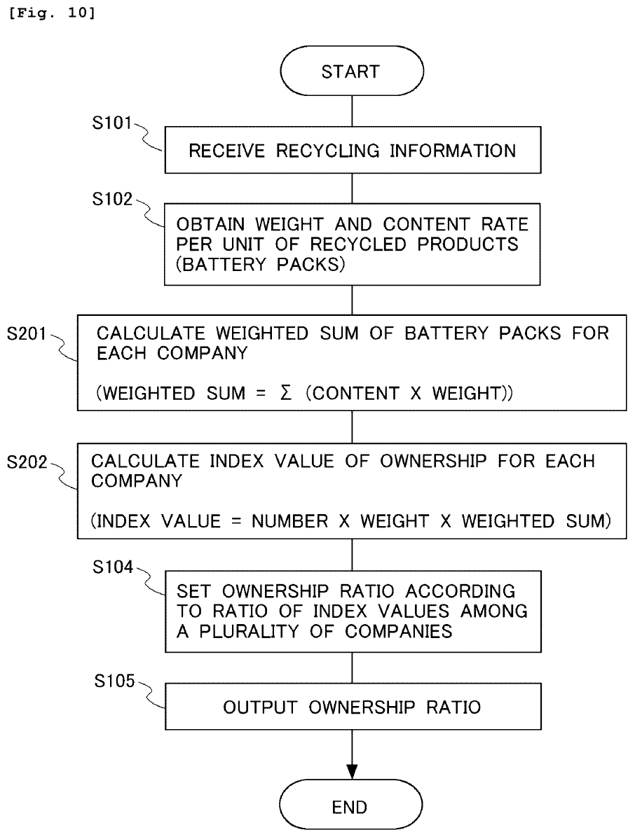

Next, a flow of processing executed by the management server 4 in the present modified embodiment will be described based on FIG. 10. FIG. 10 is a flowchart illustrating an example of a processing routine executed by the management server 4 with the reception of the recycling information transmitted from the base terminal 3 as a trigger. In the processing routine of FIG. 10, the processes of steps S201 and S202 are executed in place of step S103 in the processing routine of FIG. 7.

In step S201, the controller 41 of the management server 4 operates as the ownership ratio determination module 412. The ownership ratio determination module 412 calculates a weighted sum of the content rates of n kinds of target metals TM1 to TMn extracted from the battery management DB 421 in step S102 (weighted sum=Σ(content rate×weighting value)). After finishing the calculation of the weighted sum for each of the products of the plurality of target companies, the ownership ratio determination module 412 executes the process of step S202.

In step S202, the ownership ratio determination module 412 calculates an ownership index value for each of the plurality of target companies by substituting, into the above-mentioned formula (2), the number of products (battery packs) included in the recycling information, the weight per unit of the products (battery packs) extracted from the battery management DB 421, and the weighted sum calculated in step S201. After finishing the process of step S202, the ownership ratio determination module 412 executes the process of step S104-S105.

### Operation and Effects of Modified Embodiment

In the above-described modified modification, in a case where two or more kinds of target metals are included in the predetermined substance produced by simultaneously recycling the products (battery packs) of a plurality of companies, the management server 4 determines the ownership ratio of the plurality of companies for the predetermined substance by multiplying the total weight of the products (battery packs) of the plurality of target companies (the weight obtained by multiplying the number of recycled products by the weight per unit of the products) by the weighted sum of the content rates of the two or more kinds of target metals contained per unit of the products. As a result, the ownership ratio of each target company can be increased as the content rates of two or more target metals increases. Further, by determining the weighting values used in calculating the weighted sum of the content rates of two or more target metals according to the market value or rarity value of each of the two or more target metals, it is possible to increase the allocation to companies that manufacture and/or sell products having a large content of target metals with high market value or rarity value. Therefore, in the case where the predetermined substance contains two or more kinds of target metals, too, the same effects as those of the above-described embodiment can be obtained.

### <Others>

The above-described embodiments are merely examples, and the present disclosure can be appropriately modified and implemented within a range not departing from the gist thereof. For example, the processing described as being performed by one device or unit may be shared and performed by a plurality of devices or units. Alternatively, the processing described as being performed by different devices or units may be performed by a single device or unit. In a computer system, it is possible to flexibly change the hardware configuration that can achieve each function of the computer system.

The present disclosure can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read only memory (ROM), a random access memory (RAM), an EPROM, an EEPROM, a magnetic card, a flash memory, an optical card, or any type of medium suitable for storing electronic commands or instructions.

What is claimed is:

1. A communication system comprising:
a plurality of first terminals;
a second terminal; and
a server;
wherein each of the plurality of first terminals is configured to transmit a first signal including a first data which includes a weight of battery packs to be recycled and a content rate of a target metal to the server; and
the second terminal is configured to transmit a second signal including a second data which includes a number of battery packs to be recycled to the server;
wherein the server is configured to execute:
calculating, in response to receiving the first signals and the second signal, a first ratio regarding a material generated in the recycling process using the first data included in the first signal and the second data included in the second signal as parameters; and
transmitting a third signal including the calculated first ratio to the plurality of first terminals.

2. An information processing apparatus controller configured to execute:
determining an ownership ratio of a plurality of companies for a predetermined substance obtained by recycling battery packs of the plurality of companies; and
outputting the ownership ratio thus determined;
including a wherein the controller is configured to determine the ownership ratio according to the number of the battery packs recycled within the ownership of each of the plurality of companies, a weight per unit of the battery packs, and a content rate of a target metal contained per unit of the battery packs.

3. The information processing apparatus according to claim 2, wherein
the recycling process comprises a process of refining a black mass produced from the battery packs to separate and produce the target metal;
the predetermined substance is the target metal produced by the recycling process; and
the ownership ratio of the plurality of companies is an allocation ratio of a total weight of the target metal produced in the recycling process to the plurality of companies.

4. The information processing apparatus according to claim 3, wherein
determining the ownership ratio comprises:
calculating an index value of the ownership of each of the plurality of companies by multiplying the number of the battery packs recycled within the ownership of each of the plurality of companies, the weight per unit of the battery packs, and the content rate of the target metal contained per unit of the battery packs; and
setting a ratio of the index values among the plurality of companies as the allocation ratio to the plurality of companies.

5. The information processing apparatus according to claim 2, wherein
the recycling process comprises a process of producing a black mass from the battery packs;
the predetermined substance is the black mass produced by the recycling process; and
the ownership ratio of the plurality of companies is an allocation ratio of a total weight of the black mass produced in the recycling process to the plurality of companies.

6. The information processing apparatus according to claim 5, wherein
determining the ownership ratio comprises:
calculating a weighted sum of content rates of two or more kinds of target metals contained per unit of the battery packs recycled within the ownership of each of the plurality of companies;
calculating an index value of the ownership of each of the plurality of companies by multiplying the number of the battery packs recycled within the ownership of each of the plurality of companies, the weight per unit of the battery packs, and the weighted sum of the two or more kinds of target metals contained per unit of the battery packs; and
setting a ratio of the index values among the plurality of companies as the allocation ratio to the plurality of companies.

7. The information processing apparatus according to claim 6, wherein a weighting value used in calculating the weighted sum is set to be larger as a market value of each of the two or more kinds of target metals is higher.

8. The information processing apparatus according to claim 6, wherein a weighting value used in calculating the weighted sum is set to be larger as a rarity value of each of the two or more kinds of target metals is higher.

9. The information processing apparatus according to claim 2, wherein outputting the ownership ratio comprises transmitting a signal for outputting the ownership ratio to terminals of the plurality of companies.

10. The information processing apparatus according to claim 2, wherein the target metal comprises at least one of lithium, cobalt, nickel, and manganese.

11. An information processing method for causing a computer to execute:
determining an ownership ratio of a plurality of companies for a predetermined substance obtained by recycling battery packs of the plurality of companies; and
outputting the ownership ratio thus determined;
wherein the computer determines the ownership ratio according to the number of the battery packs recycled within the ownership of each of the plurality of companies, a weight per unit of the battery packs, and a content rate of a target metal contained per unit of the battery packs.

12. The information processing method according to claim 11, wherein
the recycling process comprises a process of refining a black mass produced from the battery packs to separate and produce the target metal;
the predetermined substance is the target metal produced by the recycling process; and
the ownership ratio of the plurality of companies is an allocation ratio of a total weight of the target metal produced in the recycling process to the plurality of companies.

13. The information processing method according to claim 12, wherein
determining the ownership ratio comprises:
calculating an index value of the ownership of each of the plurality of companies by multiplying the number of the battery packs recycled within the ownership of each of the plurality of companies, the weight per unit of the battery packs, and the content rate of the target metal contained per unit of the battery packs; and
setting a ratio of the index values among the plurality of companies as the allocation ratio to the plurality of companies.

14. The information processing method according to claim 11, wherein
the recycling process comprises a process of producing a black mass from the battery packs;
the predetermined substance is the black mass produced by the recycling process; and
the ownership ratio of the plurality of companies is an allocation ratio of a total weight of the black mass produced in the recycling process to the plurality of companies.

15. The information processing method according to claim 14, wherein
determining the ownership ratio comprises:
calculating a weighted sum of content rates of two or more kinds of target metals contained per unit of the battery packs recycled within the ownership of each of the plurality of companies;
calculating an index value of the ownership of each of the plurality of companies by multiplying the number of the battery packs recycled within the ownership of each of the plurality of companies, the weight per unit of the battery packs, and the weighted sum of the two or more kinds of target metals contained per unit of the battery packs; and
setting a ratio of the index values among the plurality of companies as the allocation ratio to the plurality of companies.

16. The information processing method according to claim 15, wherein a weighting value used in calculating the weighted sum is set to be larger as a market value of each of the two or more kinds of target metals is higher.

17. The information processing method according to claim 15, wherein a weighting value used in calculating the weighted sum is set to be larger as a rarity value of each of the two or more kinds of target metals is higher.

18. The information processing method according to claim 11, wherein outputting the ownership ratio comprises transmitting a signal for outputting the ownership ratio to terminals of the plurality of companies.

19. The information processing method according to claim 11, wherein the target metal comprises at least one of lithium, cobalt, nickel, and manganese.
